(19) United States
(12) Patent Application Publication
(10) Pub. No.: US 2005/0140803 A1
(43) Pub. Date: Jun. 30, 2005

(54) Image processing apparatus, method thereof, and image sensing apparatus

(76) Inventors: Masanori Ohtsuka, Kanagawa (JP); Masao Shikaumi, Tokyo (JP); Yusuke Mitarai, Kanagawa (JP)

Correspondence Address: MORGAN & FINNEGAN, L.L.P., 3 WORLD FINANCIAL CENTER, NEW YORK, NY, 10281-2101, US

(21) Appl. No.: 11/020,067

(22) Filed: Dec. 21, 2004

(30) Foreign Application Priority Data
Dec. 24, 2003 (JP) 2003-427704

(51) Int. Cl. H04N 5/262

(52) U.S. Cl. 348/239

(57) ABSTRACT

Photographed image data is segmented into a plurality of image areas, and whether a pink-eye effect occurs in each of the plurality of image areas is detected. The original photographed image data is stored together with image data of an image area in which the detected pink-eye effect is corrected and its correction information. If the result of pink-eye correction is unsatisfactory to the user, the image area of the original image can be designated to perform pink-eye correction again.

### FIELD OF THE INVENTION

The present invention relates to an image processing apparatus and method thereof and image sensing apparatus which detect a pink-eye effect in a photographed image and correct the pink-eye effect.

### BACKGROUND OF THE INVENTION

In photography using the electronic flash of a camera, the pupils of an object may turn red or gold, i.e., a so-called pink-eye effect may occur. This effect is generated when electronic flash light is reflected by the retinas of the pupils of the object. The effect often occurs when the pupils are dilated in a dark environment or when the distance between the electronic flash light emission unit and the photographing lens is short. A camera which has a pink-eye relaxation function of relaxing pink-eye by contracting the pupils by lighting a lamp or performing electronic flash pre-emission before real photography has conventionally and widely been used to cope with the effect. With this function, when the object gazes at a pink-eye relaxation illumination, the pink-eye effect can considerably be suppressed, and the degree of each pink-eye effect can be relaxed. Accordingly, the function is generally used not only in silver halide cameras but also in digital cameras.

Japanese Patent No. 3,114,103 discloses a technique for performing both electronic flash light emission photography and electronic flash light non-emission photography in electronic flash photography and correcting any pink-eye effect generated in the electronic flash light emission photography using an image obtained in the electronic flash light non-emission photography. With this function, not fixed pink-eye correction but pink-eye correction based on raw image information of the object can be performed. Accordingly, pink-eye correction can be performed in a more natural manner.

Object recognition and face area detection are introduced and implemented in various references. In, e.g., Japanese Patent Laid-Open No. 2000-137738, a face candidate area which is presumed to correspond to the face of a person is extracted from an image to be processed, and the face candidate area is segmented into a predetermined number of blocks. The intensity of each edge along the vertical direction of the image is calculated, and feature amounts such as the calculated edge intensity are calculated for each block. The feature amount calculated for each block is collated with a matching pattern obtained by calculating an edge enhancement integrated value for each block, thereby implementing accurate face detection.

As for a pink-eye relaxation function, the pupils of an object must be contracted to relax any pink-eye effect, and the pupils need to be irradiated with light of a certain intensity. For this reason, a time lag occurs before photography, and the following cases may happen. More specifically, even if the photographer performs shutter release, the shutter may not be released immediately, and the photographer may miss a shutter chance. Alternatively, the photographer may mistakenly assume that the apparatus is out of order when the shutter is not released immediately. On the contrary, the photographer may mistakenly assume that photography is successfully complete even when the shutter has not been released. Light to be applied for a predetermined time needs to have a certain intensity, and thus light energy for the light is necessary. This exhausts the battery in, particularly, a battery-powered device such as a camera, cellular phone with a camera, or the like.

The pink-eye relaxation function exhibits a wide variation in its effect, and the variation depends on the physical condition of an object and the characteristics unique to the object. The function may or may not be effective depending on the case or person. The function has been unable to completely prevent pink-eye effects. The function is not effective when the object looks away from illumination for pink-eye relaxation.

A case will be considered wherein electronic flash light non-emission photography is performed by the above-mentioned technique for performing electronic flash light emission photography and electronic flash light non-emission photography in electronic flash photography. A pink-eye effect occurs when the pupils of an object are dilated in a dark environment. Accordingly, a shutter time within an allowable range does not result in sufficient exposure. For this reason, sufficient image data cannot be obtained in the most important situation (the best shutter chance). To obtain sufficient image data, prolonged exposure is required. This causes a camera shake or movement of the object. In addition to poor usability and inconvenience, image data for pink-eye correction cannot often be obtained satisfactorily.

Each of the object recognition technique, face area detection using the technique, and pink-eye detection and pink-eye correction, as described above, is very useful. However, the technique does not give little consideration to how to process image storing when the techniques are actually incorporated in a photographing apparatus such as a camera. This problem must be given much consideration in a portable device such as a digital camera, video camera, cellular phone with a camera, or the like which has limited operation speed and memory capacity.

It is desirable to perform pink-eye correction again without degradation in image quality if the photographer is not sufficiently satisfied with performed pink-eye correction. The above-mentioned references do not refer to such function.

### SUMMARY OF THE INVENTION

The present invention has been made in consideration of the above-mentioned problems, and has as its features to provide an image processing apparatus, method thereof and image sensing apparatus which can provide flexibility in recorrection by storing pink eye-corrected image information and uncorrected image information for photographed image information.

According to the present invention, the foregoing object is attained by providing an image processing apparatus comprising: pink-eye detection means for detecting whether a pink-eye effect occurs in each of a plurality of image areas into which photographed image data is segmented; pink-eye correction means for correcting a pink-eye effect detected by the pink-eye detection means; and storage means for storing the photographed image data and image data of an image area in which a pink-eye effect is detected by the pink-eye detection means and is corrected by the-pink-eye correction means.

According to another aspect of the present invention, the foregoing object is attained by providing an image sensing apparatus comprising: photographing means for photographing an object using an image sensing element; pink-eye detection means for detecting whether a pink-eye effect occurs in each of a plurality of image areas into which image data photographed by the photographing means is segmented; pink-eye correction means for correcting a pink-eye effect detected by the pink-eye detection means; and storage means for storing the image data photographed by the photographing means and image data of an image area in which a pink-eye effect is detected by the pink-eye detection means and is corrected by the pink-eye correction means.

Other features, objects and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an electronic camera according to an embodiment of the present invention;

FIG. 2 is a block diagram showing the arrangement of a pink-eye detection correction unit according to this embodiment;

FIG. 3 is a flowchart showing a main routine process in the electronic camera according to this embodiment;

FIGS. 4A and 4B are flowcharts showing the main routine process in the electronic camera according to this embodiment;

FIG. 5 is a flowchart showing a distance measurement/photometry process in the electronic camera according to this embodiment;

FIGS. 6A and 6B are flowcharts for explaining a photographing process in an electronic camera according to the first embodiment;

FIG. 7 is a flowchart for explaining the first modification of the photographing process in the electronic camera according to the first embodiment;

FIG. 8 is a flowchart for explaining the second modification of the photographing process in the electronic camera according to the first embodiment;

FIG. 9 is a flowchart for explaining the third modification of the photographing process in the electronic camera according to the first embodiment;

FIG. 10 is a flowchart for explaining the fourth modification of the photographing process in the electronic camera according to the first embodiment;

FIG. 11 depicts a view showing an example of the memory map of the memory of the electronic camera according to this embodiment;

FIGS. 12A and 12B are flowcharts for explaining a photographing process in an electronic camera according to the second embodiment;

FIG. 13 is a flowchart for explaining a recording process in the electronic camera according to this embodiment;

FIG. 14 is a flowchart for explaining a modification of the recording process according to this embodiment;

FIGS. 15A to 15C depict views for explaining examples of image segmentation and face portion extraction according to this embodiment; and

FIG. 16 is a flowchart for explaining a pink eye-corrected image recorrection process according to this embodiment.

### DETAILED DESCRIPTION OF THE PREFERRED EMBODIMENTS

Preferred embodiments of the present invention will be described in detail with reference to the accompanying drawings.

### First Embodiment

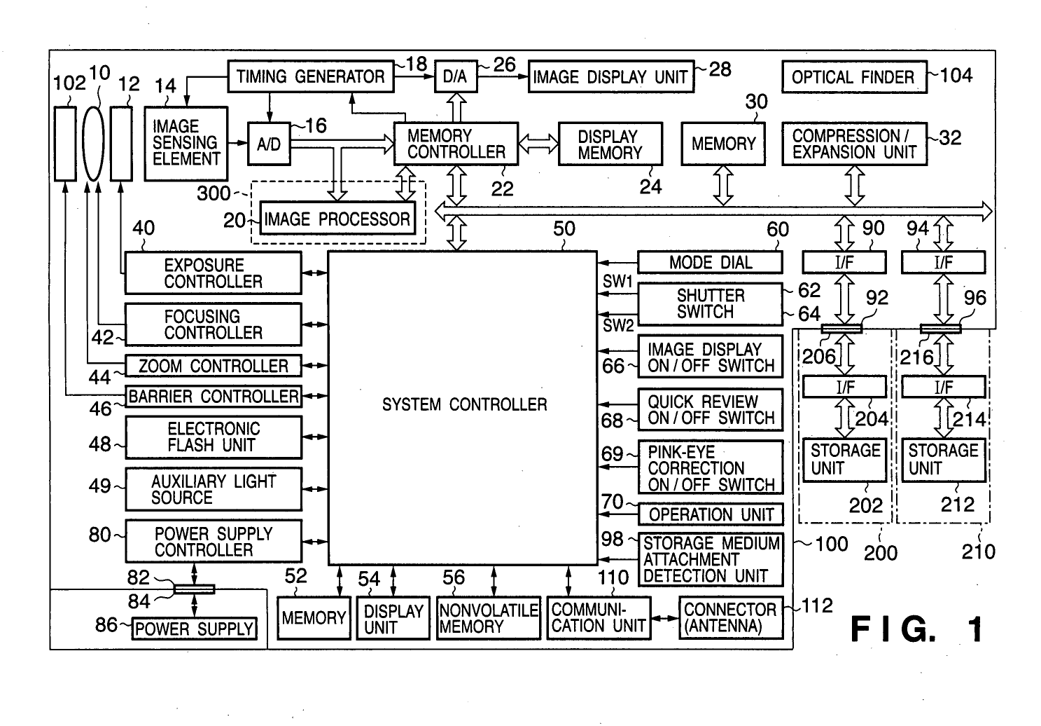

FIG. 1 is a block diagram showing the arrangement of an electronic camera (image processing apparatus) 100 according to an embodiment of the present invention.

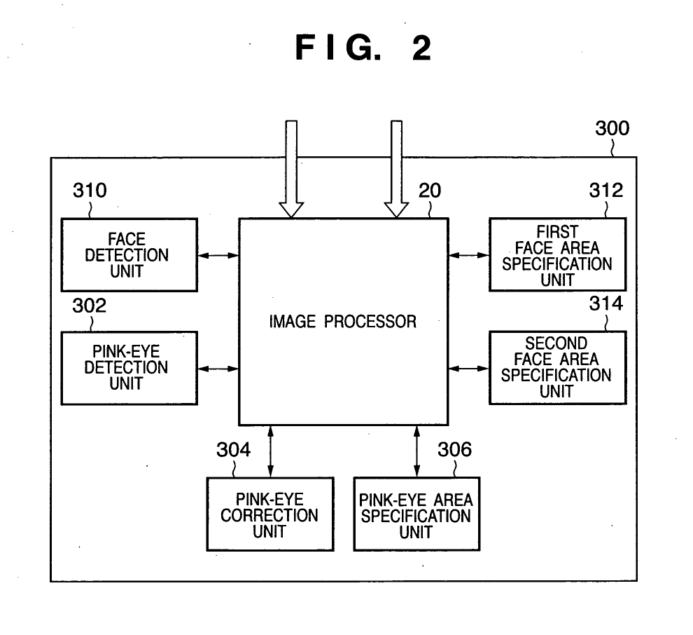

Referring to FIG. 1, reference numeral 10 denotes a photographing lens; numeral 12 denotes a shutter; numeral 14 denotes an image sensing element which converts an optical image into an electrical signal; and numeral 16 denotes an A/D converter which converts an analog signal output from the image sensing element 14 into a digital signal. A timing generator 18 supplies a clock signal and a control signal to the image sensing element 14, the A/D converter 16, and a D/A converter 26 to control the operation of the units. The timing generator 18 is controlled by a memory controller 22 and a system controller 50. An image processor 20 executes predetermined pixel interpolation processing and color conversion processing for data from the A/D converter 16 or data from the memory controller 22. The image processor 20 also executes predetermined arithmetic processing by using sensed image data. On the basis of the obtained arithmetic result, the system controller 50 controls an exposure controller 40 and a distance measurement (focusing) controller 42. More specifically, the system controller 50 executes AF (Auto Focus) processing, AE (Auto Exposure) processing, and EF (Electronic Flash pre-emission) processing of TTL (Through The Lens) scheme. The image processor 20 also executes predetermined arithmetic processing by using the sensed image data and executes AWB (Auto White Balance) processing of TTL scheme on the basis of the obtained arithmetic result. Note that a pink-eye detection correction unit 300 including the image processor 20 will be described later in detail with reference to FIG. 2.

The memory controller 22 controls the A/D converter 16, the timing generator 18, the image processor 20, a display memory 24, the D/A converter 26, a memory 30, and a compression/expansion unit 32. Data from the A/D converter 16 is written in the display memory 24 or the memory 30 through the image processor 20 and memory controller 22, or directly through the memory controller 22.

The display memory 24 stores data to be displayed on an image display unit 28. Data stored in the display memory 24 is output and displayed through the D/A converter 26 on the image display unit 28 such as a TFT, LCD, or the like. When sensed image data is sequentially displayed using the image display unit 28, an electronic finder function can be implemented. The image display unit 28 can arbitrarily turn on/off display in accordance with an instruction from the system controller 50. When display is turned off, power consumption of the image processing apparatus 100 can largely be reduced. The image display unit 28 can display an image having undergone pink-eye correction by a pink-eye correction unit 304 in FIG. 2 (to be described later), an area having undergone pink-eye correction by a pink-eye area specification unit 306, or a face area where a pink-eye effect occurs by a second face area specification unit 314.

The memory 30 stores a photographed still image or moving image. The memory 30 has a storage capacity large enough to store a predetermined number of still images or a moving image for a predetermined time. Accordingly, even in panoramic photography or continuous shooting for continuously taking a plurality of still images, a large quantity of images can quickly be written in the memory 30. The memory 30 can also be used as a work area of the system controller 50 or that of the pink-eye detection correction unit 300. The compression/expansion unit 32 can compress and expand image data by, e.g., Adaptive Discrete Cosine Transform (ADCT) or wavelet transform. The compression/expansion unit 32 can load image data stored in the memory 30 to execute compression processing or can load compressed image data to execute expansion processing and write the processed data in the memory 30.

The exposure controller 40 controls the shutter 12 having an iris. The exposure controller 40 also has a flash brightness control function in cooperation with an electronic flash 48. The focusing controller 42 controls focusing of the photographing lens 10 and detects the distance of an object from the focusing position of the photographing lens 10. A zoom controller 44 controls zooming of the photographing lens 10. A barrier controller 46 controls the operation of a protection unit 102. The electronic flash unit 48 has an AF auxiliary light projecting function and electronic flash light control function. The exposure controller 40 and focusing controller 42 are controlled by the TTL scheme. On the basis of an arithmetic result obtained from the image processor 20 by processing sensed image data, the system controller 50 controls the exposure controller 40, focusing controller 42, and barrier controller 46. An auxiliary light source 49 is used as an auxiliary light source for through display in the dark, auxiliary light for the focusing controller 42, or lighting for pink-eye relaxation.

The system controller 50 controls the entire image processing apparatus 100. A memory 52 stores constants, variables, and programs for the operations of the system controller 50 and is used as a work memory. A indicator unit 54 includes a liquid crystal display unit, speaker, and the like which indicate the operation state or a message by using characters, images, or sound in accordance with execution of a program by the system controller 50. One or a plurality of display units 54 are arranged at visible positions near an operation unit 70 of the image processing apparatus 100. The indicator unit 54 includes a combination of, e.g., an LCD, LED, sound generation element, and the like. Part of the indicator unit 54 is arranged in an optical finder 104. Of the indication contents of the indicator unit 54, examples of indication on the LED or the like are the single shot/continuous shooting mode, self timer, compression ratio, number of recording pixels, number of recorded images, number of recordable images, shutter speed, F-number, exposure compensation, electronic flash, pink-eye relaxation, pink-eye correction, macro photography, buzzer setting, timer battery level, battery level, error, information by a plurality of digits, attached state of a storage medium 200 or 210, operation of communication I/F, and date/time. Of the indication contents of the indicator unit 54, examples of indication in the optical finder 104 are in-focus, camera shake warning, electronic flash charge, shutter speed, F-number, and exposure compensation.

An electrically erasable/recordable (storable) nonvolatile memory 56 is, e.g. an EEPROM. A mode dial 60, shutter switches 62 and 64, an image display ON/OFF switch 66, a quick review ON/OFF switch 68, and the operation unit 70 are operation units for inputting various kinds of operation instructions of the system controller 50. They include single devices such as a switch, dial, touch panel, or pointing by detection of a line of sight, and voice recognition device, or a combination of a plurality of devices.

These operation units will be described here in detail.

The mode dial switch 60 can selectively set function modes such as power off, auto photography mode, photography mode, panoramic photography mode, playback mode, multiwindow playback/erase mode, and PC connection mode. The shutter switch (SW1) 62 is turned on midway during the operation of a shutter button (not shown) and instructs the start of an operation such as AF (Auto Focus) processing, AE (Auto Exposure) processing, or AWB (Auto White Balance) processing. The shutter switch (SW2) 64 is turned on at the end of operation of a shutter button (not shown) and in an electronic flash photographing mode, instructs the start of a series of processing operations including. control of light emitted from the electronic flash unit 48, exposure processing for writing an image signal read from the image sensing element 14 in the memory 30 through the A/D converter 16 and memory controller 22, development processing using arithmetic processing by the image processor 20 or memory controller 22, pink-eye detection and correction processing by the pink-eye detection correction unit 300, and recording (storage) processing for causing the compression/expansion unit 32 to compress the image data and writing it in the storage medium 200 or 210. The image display ON/OFF switch 66 can set ON/OFF of the image display unit 28. With this function, current supply to the image display unit 28 comprising a TFT, LCD, or the like can be stopped in photography using the optical finder 104 so that the power consumption can be reduced. The quick review ON/OFF switch 68 sets a quick review function of automatically playing back photographed image data immediately after photography. In this embodiment, especially, the quick review function is set when the image display unit 28 is OFF. A pink-eye correction ON/OFF switch 69 sets a pink-eye correction mode function as to whether to perform pink-eye detection and pink-eye correction. In this embodiment, pink-eye detection and pink-eye correction are performed only when the pink-eye correction ON/OFF switch 69 is turned on. The operation unit 70 includes various kinds of buttons and a touch panel. The switches and buttons of the operation unit 70 include a menu button, set button, macro button, multiwindow playback page break button, electronic flash setting button, single shot/continuous shot/self timer switching button, menu move + (plus) button, menu move − (minus) button, playback image move + (plus) button, playback image move − (minus) button, photographed image quality selection button, exposure compensation button, date/time setting button, pink-eye relaxation button, pink-eye correction button, pink-eye edit button, and pink-eye correction print button.

A power supply controller 80 includes a battery detection unit, DC/DC converter, and switch unit which selects a block to be energized. The power supply controller 80 detects the presence/absence of a battery, battery type, and battery level, controls the DC/DC converter on the basis of the detection result and an instruction from the system controller 50, and supplies a necessary voltage to the units including a storage medium for a necessary period. Reference numerals 82 and 84 denote connectors. A power supply unit 86 includes a primary cell such as an alkaline cell or lithium cell, a secondary cell such as an NiCd cell, NiMH cell, or Li cell, or an AC adapter.

Reference numerals 90 and 94 denote interfaces to the storage media such as a memory card and hard disk; numeral 92 and 96 denote connectors connected to the storage media such as a memory card and hard disk; and numeral 98 denotes a storage medium attachment detection unit which detects whether the storage medium 200 or 210 is attached to the connector 92 or 96.

This embodiment will be described assuming that the apparatus has two systems of interfaces and connectors to which storage media are attached. The apparatus may have one or a plurality of systems of interfaces and connectors to which storage media are attached, as a matter of course. In addition, interfaces or connectors of different standards may be combined. Interfaces and connectors based on a standard such as a PCMCIA card or CF (compact flash™) card may be used.

When the interfaces 90 and 94 and connectors 92 and 96 based on a standard such as a PCMCIA card or CF (compact flash™) card are used, and various kinds of communication cards such as a LAN card, modem card, USB card, IEEE1394 card, P1284 card, SCSI card, or communication card for PHS is connected, image data or management information associated with the image data can be transferred to/from another computer or a peripheral device such as a printer.

The protection unit 102 serves as a barrier which covers the image sensing unit including the lens 10 of the image processing apparatus 100 to prevent any dirt or damage to the image sensing unit. Photography can be executed by using only the optical finder 104 without using the electronic finder function by the image display unit 28. The optical finder 104 incorporates some functions of the indicator unit 54, including” e.g., in-focus indication, camera shake warning indication, electronic flash charge indication, shutter speed indication, F-number indication, and exposure compensation indication. A communication unit 110 has various kinds of communication functions such as RS232C, USB, IEEE1394, P1284, SCSI, modem, LAN, and wireless communication. An antenna (connector) 112 connects the image processing apparatus 100 to another device via the communication unit 110. The connector 112 serves as a connector for wired communication while it serves as an antenna for wireless communication. The storage medium 200 includes a memory card or hard disk. The storage medium 200 comprises a storage unit 202 including a semiconductor memory or magnetic disk, an interface 204 to the image processing apparatus 100, and a connector 206 connected to the image processing apparatus 100. The storage medium 210 includes a memory card or hard disk. The storage medium 210 comprises a storage unit 212 including a semiconductor memory or magnetic disk, an interface 214 to the image processing apparatus 100, and a connector 216 connected to the image processing apparatus 100.

The pink-eye detection correction unit 300 including the image processor 20 will be described with reference to FIG. 2. FIG. 2 is a block diagram for explaining the arrangement of the pink-eye detection correction unit 300 according to this embodiment.

A pink-eye detection unit 302 detects whether any pink-eye effect occurs in digital data from the A/D converter 16 or image data from the memory controller 22 and whether the pink-eye effect is at a level which requires correction. The pink-eye correction unit 304 corrects any pink-eye effect detected by the pink-eye detection unit 302. The pink-eye area specification unit 306 specifies an area of the image data actually corrected by the pink-eye correction unit 304. A face detection unit 310 detects a face portion (face area) of an object from the image data. A first face area specification unit 312 specifies the face area detected by the face detection unit 310. The second face area specification unit 314 specifies only a face sub-area in which a pink-eye effect has occurred in the face area specified by the first face area specification unit 312. These units are connected to the image processor 20, and exchange of image data, control, or the like is performed between them.

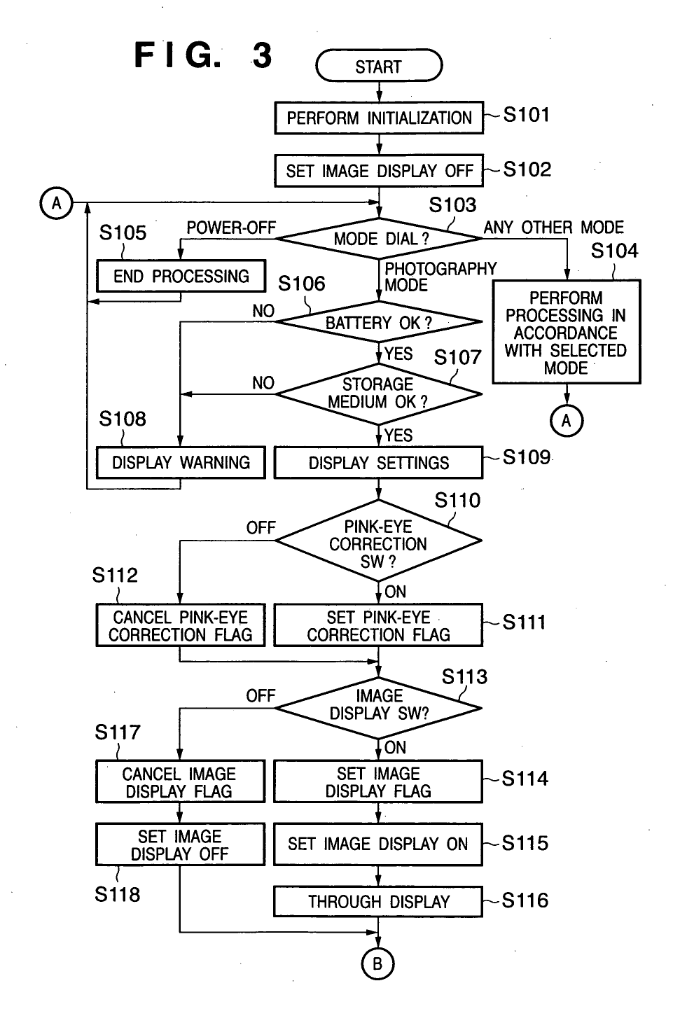

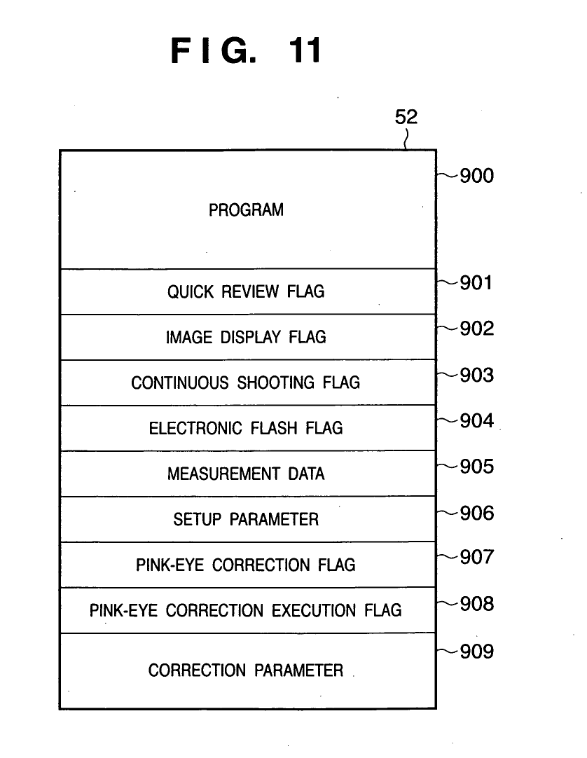

The operation of the electronic camera 100 according to the first embodiment will be described with reference to FIGS. 3 to 10. In this embodiment, a program (reference numeral 900 in FIG. 11) for executing the process is stored in the memory 52 and is implemented under the control of the system controller 50. FIG. 11 depicts an example of the memory map of the memory 52. Although in FIG. 11, various kinds of flags and data are stored in the memory 52, these data may be stored in the memory 30 or the internal memory of the system controller 50.

In FIG. 11, a quick review flag 901 is set ON when the quick review ON/OFF switch 68 is turned on. An image display flag 902 is set ON when the image display ON/OFF switch 66 is turned on. A continuous shooting flag 903 is set ON when a continuous shooting mode is set. An electronic flash flag 904 is set ON when a mode using the electronic flash is set. Measurement data 905 is data including photometry data obtained by photometry. Parameters such as an F-number, focus, and the like at the time of photometry are stored in the field for setup parameters 906. A pink-eye correction flag 907 is set ON when the pink-eye correction ON/OFF switch 69 is ON. A pink-eye correction execution flag 908 is set for an image area in which pink-eye correction is actually performed (to be described later) and is set together with identification information indicating the area. The procedure for the pink-eye correction, coordinate data indicating the coordinate position of pink-eye correction, a parameter for pink-eye correction, and the like are stored in the field for correction parameters 909. The flags interlocked with the switches are set OFF when the respective modes are reset by operation of the switches.

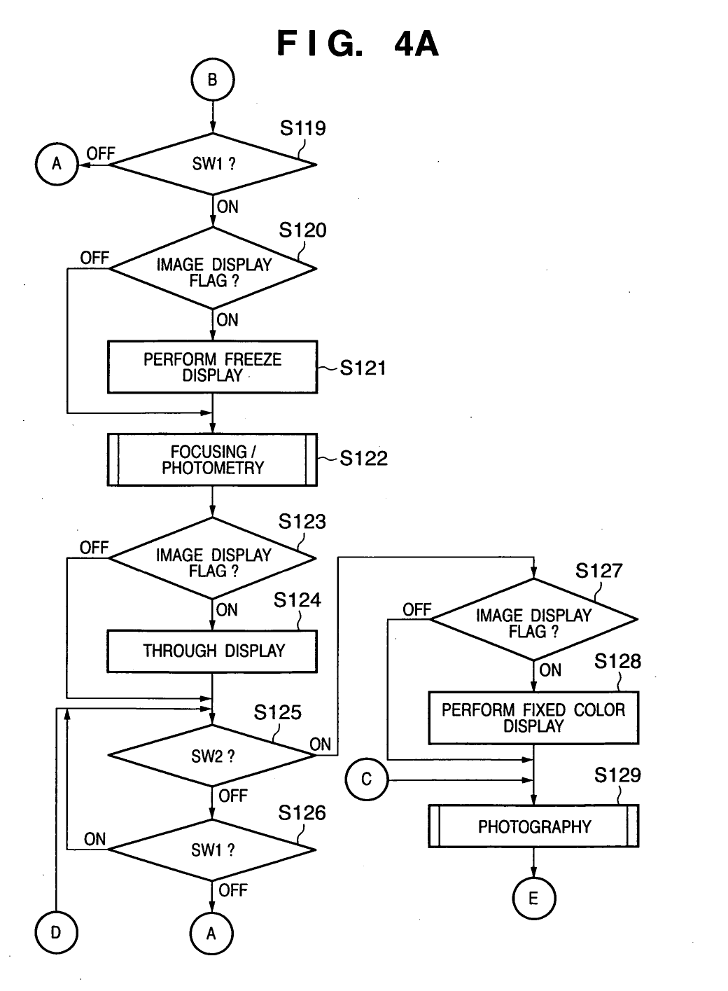

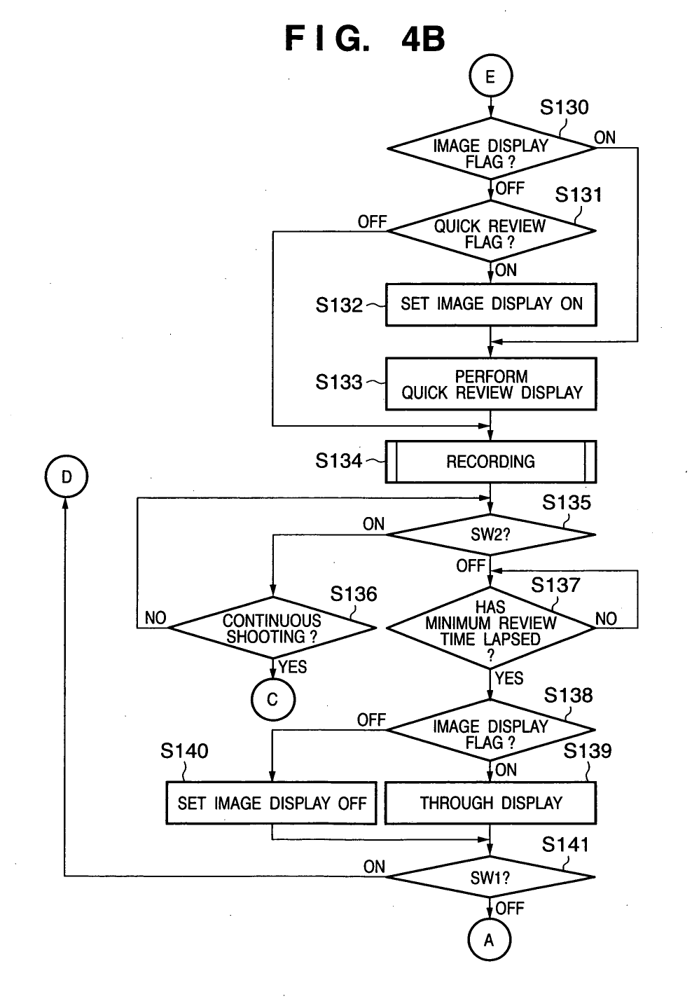

FIGS. 3, 4A and 4B are flowcharts for explaining the operation of a main routine-process in the electronic camera (image processing apparatus) 100 according to this embodiment.

This process starts when the apparatus is powered on by, e.g., loading a new battery. In step S101, the system controller 50 initializes various kinds of flags and control variables in the memory 52. In step S102, the system controller 50 initializes the display states of the image display unit 28 and display unit 54 to the OFF state. In step S103, the system controller 50 determines the set position of the mode dial 60. If the mode dial 60 is set to power OFF, the flow advances to step S105. In step S105, the display states of display units are changed to the end state. The barrier of the protection unit 102 is closed to protect the image sensing unit. Necessary parameters, set values, and set modes, including flags and control variables, are stored in the nonvolatile memory 56. The power supply controller 80 cuts off unnecessary power of the units of the image processing apparatus 100, including the image display unit 28. After the predetermined end processing is executed, the flow returns to step S103.

If it is determined instep S103 that the mode dial 60 is set to the photography mode, the flow advances to step S106. On the other hand, if it is determined that the mode dial 60 is set to any other mode, the flow advances to step S104. In step S104, the system controller 50 executes processing corresponding to the mode selected by the mode dial 60. After the end of the processing, the flow returns to step S103.

As described above, if the mode dial 60 is set to the photography mode, the flow advances to step S106. In step S106, the system controller 50 determines on the basis of a signal from the power supply controller 80 whether the level or operation situation of the power supply 86 including a battery or the like has a problem. This problem occurs when, e.g., the battery level is less than a predetermined value, and photography cannot be performed. If any problem is found, the flow advances to step S108. In step S108, a predetermined warning is displayed on the display unit 54 by an image or sound, and the flow returns to step S103.

If YES in step S106, the flow advances to step S107. In step S107, the system controller 50 determines whether the operation state of the storage medium 200 or 210 has a problem for the operation of the image processing apparatus 100 and, more particularly, the image data storage/playback operation for the storage medium. If NO (e.g., the storage medium is not mounted or the storage medium cannot be read) in step S107, the flow advances to step S108. In step S108, a predetermined warning is displayed on the display unit 54 by an image or sound, and the flow returns to step S103.

If YES in step S107, the flow advances to step S109 to cause the indicator unit 54 to display the UI of various set states of the image processing apparatus 100 by an image or sound. If image display of the image display unit 28 is ON (the image display ON/OFF switch 66 is ON), the UI of various set states of the image processing apparatus 100 are displayed by an image or sound by using even the image display unit 28. In this manner, various settings are made by the user using the UI. In step S110, the system controller 50 checks the set state of the pink-eye correction ON/OFF switch 69. If the pink-eye correction mode is set ON, the flow advances to step Sill to set the pink-eye correction flag 907 (FIG. 11) ON. On the other hand, if the pink-eye correction mode is set OFF in step S110, the flow advances to step S112 to set the pink-eye correction flag 907 OFF.

The flow advances to step S113 to check the set state of the image display ON/OFF switch 66. If image display is set ON, the flow advances to step S114 to set the image display flag 902 in the memory 52 ON. In step S115, image display of the image display unit 28 is set to the ON state. In step S116, a through display state that sequentially displays image data sensed by the image sensing element 14 is set, and the flow advances to step S119 (FIG. 4A). In the through display state, data which are sequentially written in the display memory 24 through the image sensing element 14, A/D converter 16, image processor 20, and memory controller 22 are sequentially displayed on the image display unit 28 through the memory controller 22 and D/A converter 26, thereby implementing the electronic finder function. Assume that the pink-eye correction mode is set, and through image display is selected. If information from the exposure controller 40 indicates that the brightness is equal to or less than a predetermined level, auxiliary light of the electronic flash unit 48 or auxiliary light source 49 is applied to detect a pink-eye state, and the through display is performed while performing display and correction.

On the other hand, if it is determined in step S113 that the image display ON/OFF switch 66 is set to image display OFF, the flow advances to step S117 to cancel the image display flag 902. In addition, in step S118, display of the image display unit 28 is set to the OFF state. Then, the flow advances to step S119. When image display is OFF, photography is performed by using the optical finder 104 without using the electronic finder function by the image display unit 28. In this case, the power consumed by the image display unit 28 and D/A converter 26, which consume large power, can be reduced.

In step S119, it is determined whether the shutter switch (SW1) 62 is ON. If it is determined that the shutter switch is OFF, the flow returns to step S103 (FIG. 3). On the other hand, it is determined that the shutter switch (SW1) 62 is ON, the flow advances to step S120 to determine whether the image display flag 902 is set ON. If the image display flag 902 is set ON, the flow advances to step S121. In step S121, the display state of the image display unit 28 is set to a freeze display state, and the flow advances to step S122. In the freeze display state, image data rewrite that is executed for the display memory 24 through the image sensing element 14, A/D converter 16, image processor 26, pink-eye detection correction unit 300, and memory controller 22 is inhibited. The finally written image data is displayed on the image display unit 28 through the memory controller 22 and D/A converter 26, thereby displaying a frozen image on the optical finder 104.

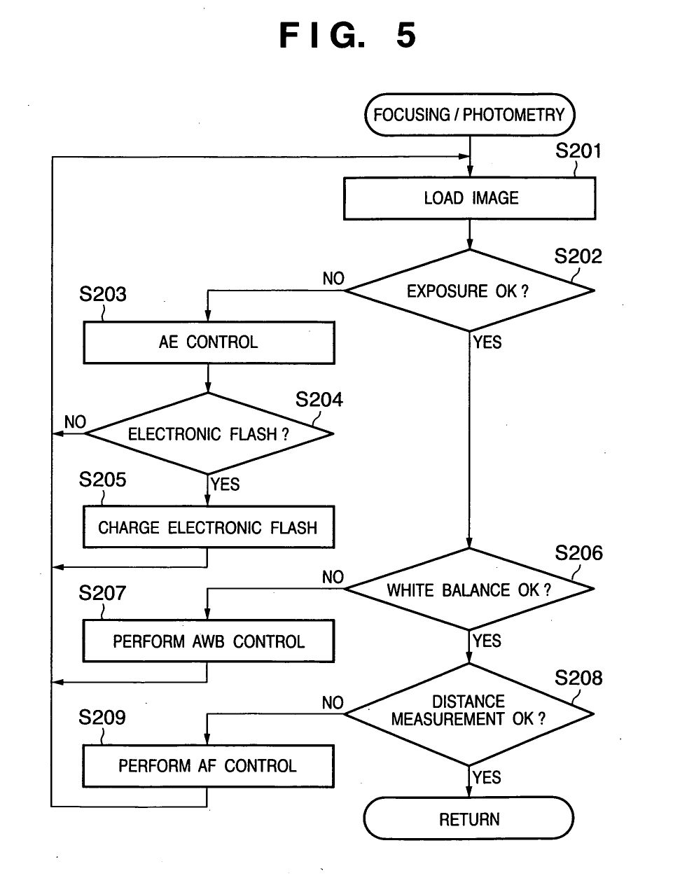

If it is determined in step S120 that the image display flag 902 is OFF, the flow advances to step S122. In step S122, the system controller 50 sets the focal length of the photographing lens 10 on an object by executing distance measurement and also decides the F-number and shutter speed by executing photometry. Setting of the electronic flash is also performed as needed in the photometry. Note that the distance measurement/photometry process (step S122) will be described later in detail with reference to the flowchart in FIG. 5.

When the distance measurement/photometry is ended in step S122, the flow advances to step S123 to determine the state of the image display flag 902. If it is determined in step S123 that the image display flag 902 is set ON, the flow advances to step S124. In step S124, the display state of the image display unit 28 is set to the through display state, and the flow advances to step S125. Note that the through display state in step S124 is the same as that in step S116.

If it is determined in step S125 that the shutter switch (SW2) 64 is not pressed, and it is determined in step S126 that the shutter switch (SW1) 62 is turned off, the flow returns to step S103 (FIG. 3).

On the other hand, if it is determined in step S125 that the shutter switch (SW2) 64 is pressed, the flow advances to step S127 to determine whether the image display flag 902 is ON. If the image display flag 902 is ON, the flow advances to step S128. In step S128, the display state of the image display unit 28 is set to a fixed color display state, and the flow advances to step S129. In the fixed color display state, fixed color image data is displayed on the image display unit 28 through the memory controller 22 and D/A converter 26 as an alternative to photographed image data written in the display memory 24 through the image sensing element 14, A/D converter 16, image processor 20, pink-eye detection correction unit 300, and memory controller 22. In this manner, fixed color image is displayed on the electronic finder 104.

If it is determined in step S127 that the image display flag 902 is OFF, the flow advances to a photographing process in step S129. In step S129, the photographing process performs exposure processing for writing photographed image data in the memory 30 through the image sensing element 14, A/D converter 16, image processor 20, pink-eye detection correction unit 300, and memory controller 22 or from the A/D converter 16 directly through the memory controller 22, and development processing for reading the image data written in the memory 30 by using the memory controller 22 and even the image processor 20 and pink-eye detection correction unit 300, as needed, and performing various kinds of processing operations.

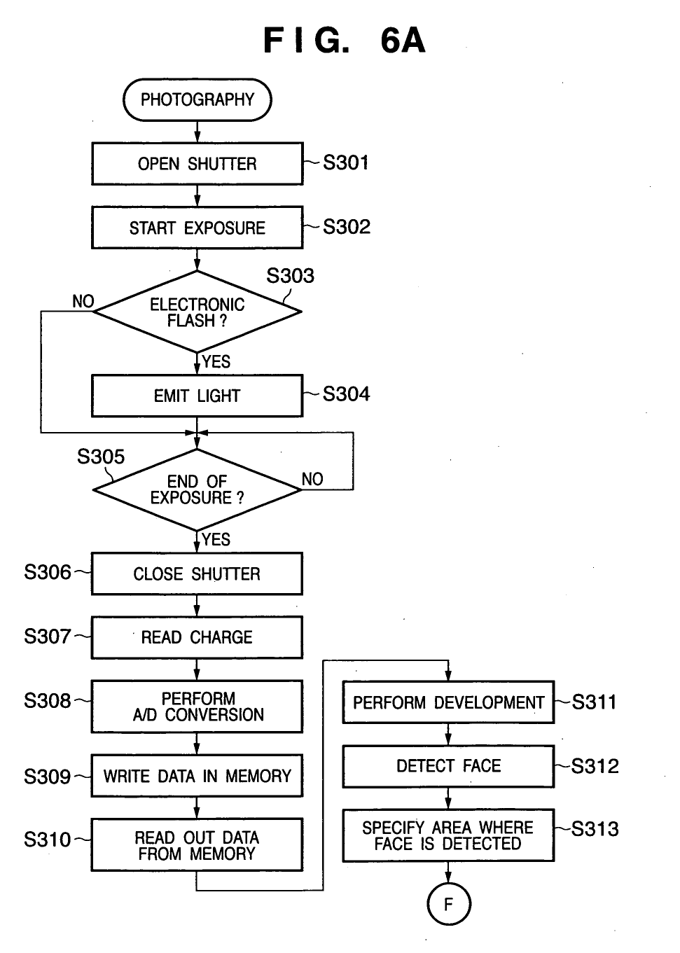

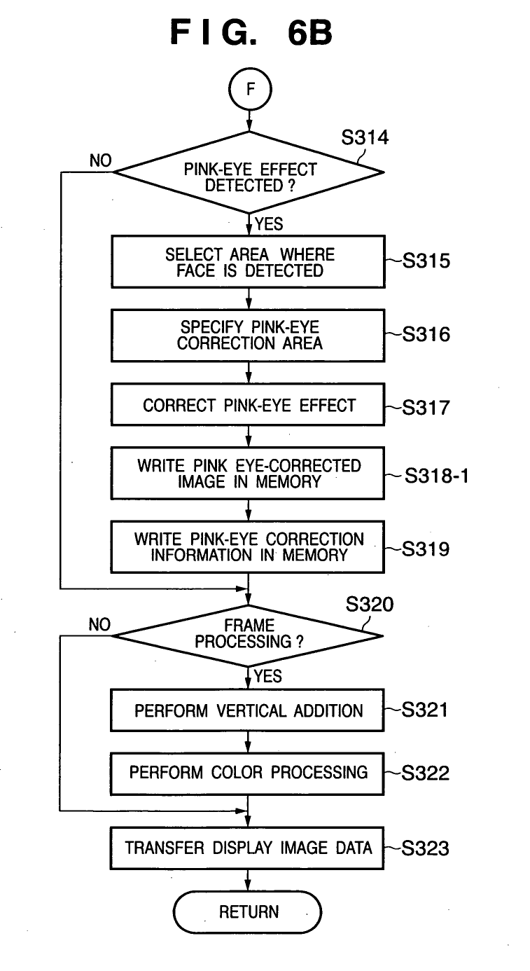

The details of the photography processing (step S129) will be described later with reference to FIGS. 6A and 6B.

When the photographing process in step S129 is performed, the flow advances to step S130. In step S130, the state of the quick review ON/OFF switch is detected in advance, and it is determined whether the image display flag 902 is ON. If the image display flag 902 is ON, the flow advances to step S133 to perform quick review display. In this case, the image display unit 28 is continuously displayed as the electronic finder even during photography, and quick review display is also performed immediately after photography.

If NO in step S130, the flow advances to step S131 to check whether the quick review flag 901 is ON. If the quick review flag 901 is ON, the flow advances to step S132 to set image display of the image display unit 28 to the ON state. In step S133, quick review display is performed, and the flow advances to step S134.

If NO in step S130 and NO in step S131, the flow advances to a recording (storage) process in step S134 while keeping the image display unit 28 in the OFF state. In this case, the image display unit 28 remains in the OFF state even after photography and does not perform quick review display. Similarly to the case of continuing photography using the optical finder 104, a photographed image need not be confirmed immediately after photography. This use does not require the electronic finder function of the image display unit 28, and places importance to power savings.

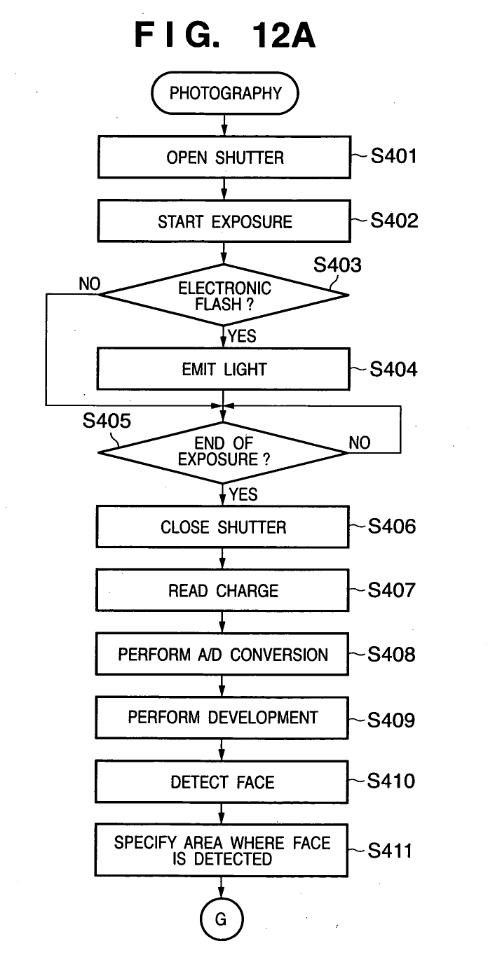

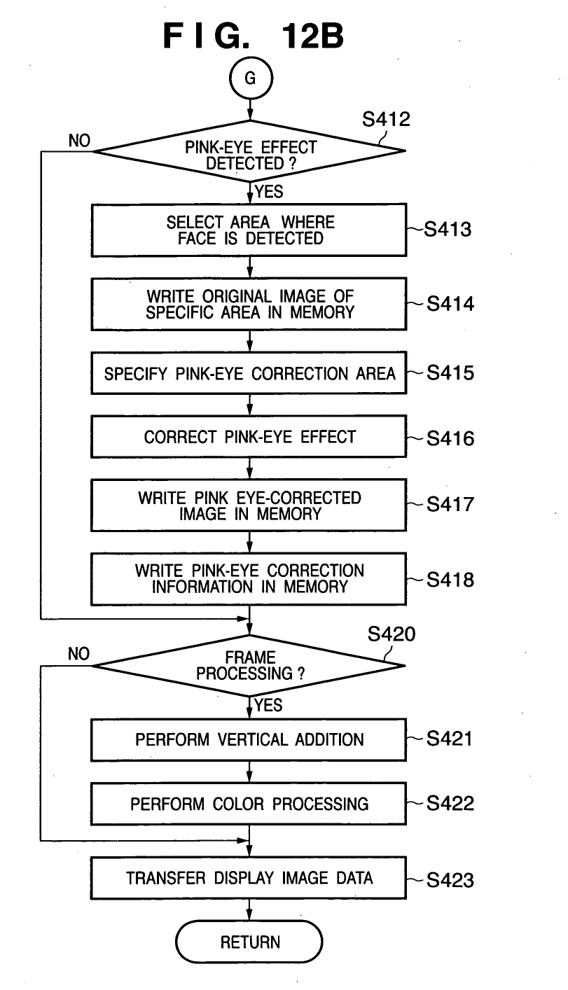

In step S134, a process (recording process) of reading photographed image data written in the memory 30, performing various kinds of image processing operations using the memory controller 22 and even the image processor 20 and pink-eye detection correction unit 300, as needed, performing an image compression process according to a set mode using the compression/expansion unit 32, and then writing the compressed image data in the storage medium 200 or 210 is performed. The details of the recording process (step S134) will be described in detail with reference to the flowcharts in FIGS. 12A and 12B.

In the recording process according to this embodiment, image data having undergone pink-eye detection and pink-eye correction and original image data before pink-eye detection and pink-eye correction are stored in the storage medium. Alternatively, the whole of the pink eye-corrected image data or a fragmented portion of original image data corresponding to a pink-eye corrected portion is stored. Alternatively, the whole of the original image data before pink-eye correction and a fragmented portion of the pink eye-corrected image data are stored. Alternatively, the image data before development and the pink eye-corrected image data after development or the compressed image data are stored. In storing image data, files corresponding to image data are saved as file names associated with them. Such file name will be described later.

When the recording process in step S134 ends, the flow advances to step S135 to check whether the shutter switch (SW2) 64 is pressed. If YES in step S135, the flow advances to step S136 to determine the state of the continuous shooting flag 903. If the continuous shooting flag 903 is ON, the flow advances to step S129 to perform continuous shooting. In step S129, the next image is photographed. On the other hand, if NO in step S136, the flow returns to step S135. The processes in steps S135 and S136 are repeated until the shutter switch (SW2) 64 is released.

Assume that the operation state is set to quick review display immediately after photography. If the continuous shooting flag 903 is OFF, and the shutter switch (SW2) 64 is continuously pressed when the recording process (step S134) ends, the image display unit 28 continues quick review display until the shutter switch (SW2) 64 is released. This operation allows careful confirmation of photographed images. In image confirmation, pink eye-corrected image data stored in step S134 is read and displayed. Alternatively, image data of an original image before pink-eye correction or pink-eye correction parameters are read, the original image is replaced with a pink eye-corrected image or the original image is subjected to pink-eye correction using the pink-eye correction parameters, and the corrected image is displayed.

If the shutter switch (SW2) 64 turned off in step S135, the flow advances to step S137. In step S137, after a predetermined minimum review time has lapsed, the flow advances to step S138. In step S138, it is checked whether the image display flag 902 is ON. If ON, the flow advances to step S139. In step S139, the display state of the image display unit 28 is set to the through display state, and then the flow advances to step S141. With this operation, after a photographed image is confirmed by quick review display on the image display unit 28, the display state can be set to the through display state for subsequent photographing, in which sensed image data are sequentially displayed. If NO in step S138, the flow advances to step S140. In step S140, display of the image display unit 28 is set to the OFF state, and flow advances to step S141. With this operation, after a photographed image is confirmed by quick review display on the image display unit 28, the function of the image display unit 28 can be stopped for power savings, thereby reducing power consumption by the image display unit 28, D/A converter 26, and the like, which consume a large amount of power.

In step S141, it is checked whether the shutter switch (SW1) 62 is turned on. If YES in step S141, the flow advances to step S125 to prepare for subsequent photography. If NO in step S141, a series of photographing operations end, and the flow returns to step S103 (FIG. 3).

FIG. 5 is a flowchart showing the details of the distance measurement/photometry process in step S122 of FIG. 4A.

In step S201, charge signals are read from the image sensing element 14 and are converted into digital data through the A/D converter 16. The obtained digital data is input to the image processor 20. Using the input image data, the image processor 20 performs predetermined operations for AE (Auto Exposure) processing, EF (Electronic Flash pre-emission) processing, and AF (Auto Focus) processing of TTL scheme. In the processing, a required number of specific portions are cut and extracted, as needed, from all photographed pixels, and are used for the operations. This allows the optimum operations for each of different modes such as center-weighted mode, average mode, evaluation mode, and the like in each of AE, EF, AWB, and AF of TTL scheme.

If it is not determined in step S202, using the operation result from the image processor 20 obtained in step S201, that exposure (AE) is appropriate, the flow advances to step S203. In step S203, AE control is performed using a combination of the barrier controller 46 and the electronic shutter of the image sensing element 14. It is determined in step S204 using the measurement data obtained in the AE control whether the electronic flash is necessary. If the electronic flash is necessary, the flow advances to step S205. In step S205, the electronic flash flag 904 is set, the electronic flash unit 48 is charged, and the flow returns to step S201.

If it is determined in step S202 that exposure (AE) is appropriate, the flow advances to step S206 to store the measurement data 905 and/or setup parameter 906 in the memory 52. It is then determined using the operation result from the image processor 20 and the measurement data 905 obtained by AE control whether the white balance is appropriate. If it is determined that the white balance is inappropriate, the flow advances to step S207. In step S207, color process parameters are adjusted using the image processor 20 to perform AWB control, and the flow advances to step S201. If it is determined in step S206 that the white balance (AWB) is appropriate, the flow advances to step S208 to store the measurement data 905 and/or setup parameter 906 in the memory 52. It is determined using the measurement data 905 obtained in the AE control and AWB control whether distance measurement (AF) is in focus. If NO in step S208, the flow advances to step S209. In step S209, AF control is performed using the focusing controller 42, and the flow advances to step S201. If it is determined in step S208 that the distance measurement (AF) is in focus, the measurement data 905 and/or setup parameter 906 is stored in the internal memory or memory 52 of the system controller 50, and the distance measurement/photometry process ends.

FIGS. 6A and 6B are flowcharts showing the details of the photographing process in step S129 of FIGS. 4A and 4B.

On the basis of the measurement data 905 (FIG. 11) obtained in the distance measurement/photometry process, the exposure controller 40 opens the shutter 12 having the stop function in accordance with the F-number to expose the image sensing element 14 (steps S301 and S302). In step S303, it is determined from the electronic flash flag 904 whether the electronic flash unit 48 is necessary. If it is determined that the electronic flash unit 48 is necessary, the flow advances to step S304 to cause the electronic flash unit 48 to emit light of a predetermined light amount. In step S305, the apparatus waits for the end of exposure of the image sensing element 14 in accordance with the measurement data 905. When the exposure ends, the shutter 12 is closed in step S306. In step S307, charge signals are read from the image sensing element 14. Photographed image data is written in the memory 30 through the A/D converter 16, image processor 20, and memory controller 22 or from the A/D converter 16 directly through the memory controller 22 (steps S308 and S309).

In step S310, the memory controller 22 reads the image data written in the memory 30 again. In step S311, the image processor 20 performs the development processing including various kinds of correction and AWB. The flow advances to step S312 to detect a face portion (face area) from image data of an image developed in step S311 by the face detection unit 310 connected to the image processor 20. In step S313, the first face area specification unit 312 specifies in which area of fragmented images the detected face area is located.

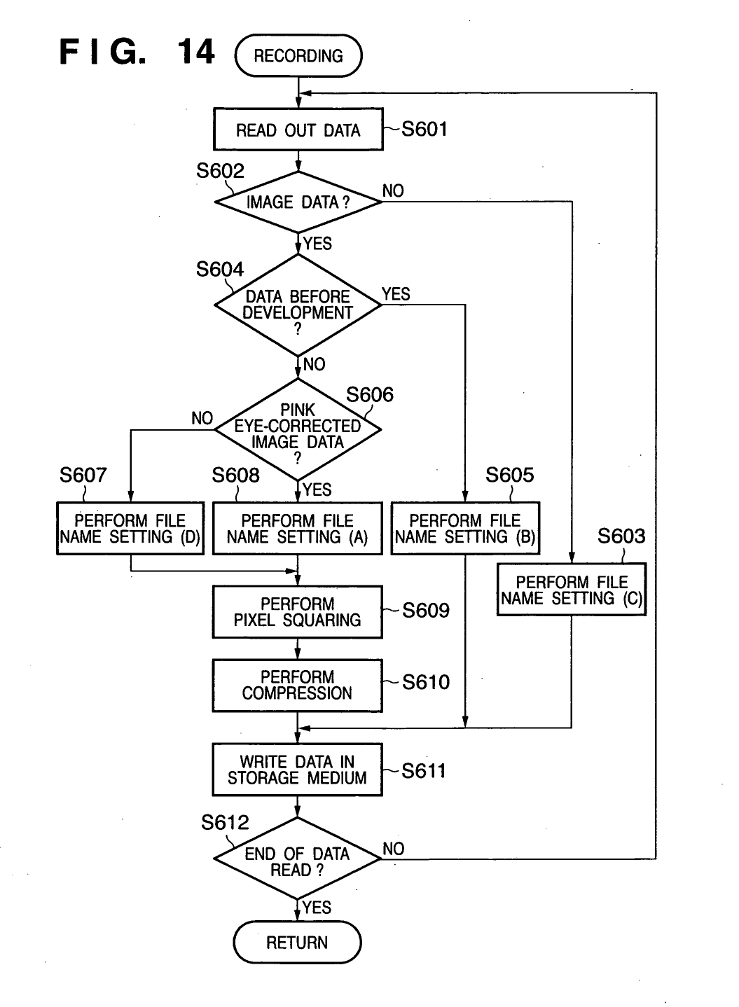

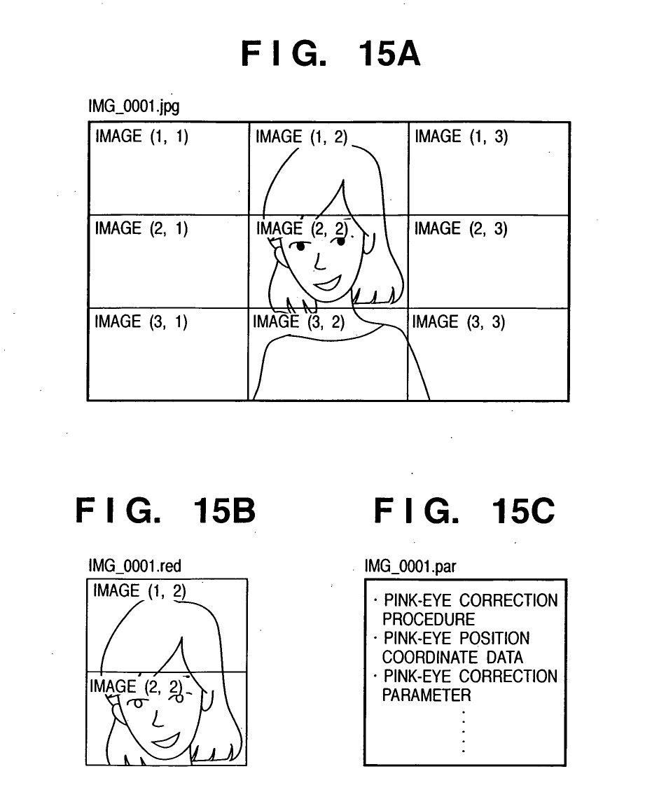

FIGS. 15A to 15C depict views for explaining a face area specification process by the first face area specification unit 312.

FIG. 15A shows an example wherein the entire image including a face is segmented into a plurality of areas. Out of the image areas, ones in which face areas are detected are areas (1,2) and (2,2). In the example of FIG. 15A, one face lies across the two areas (1,2) and (2,2). If a plurality of faces are detected, all image areas containing the faces are specified. FIG. 15B depicts a view obtained by extracting only the image areas (1,2) and (2,2) containing the face. FIG. 15C depicts a view for explaining a file which stores the procedure for pink-eye correction and its correction parameters (to be described later).

Referring back to FIGS. 6A and 6B, in step S314, the pink-eye detection unit 302 detects any pupil from each image area specified in step S313, determines whether the pupil contains any pink-eye effect, and determines whether the pink-eye effect is at a level which requires correction. If it is determined that pink-eye correction should be performed, the flow advances to step S315. In step S315, the second face area specification unit 314 determines whether each image area specified in step S313 contains any pink-eye effect and selects any image area containing a pink-eye effect. Then, the flow advances to step S316.

With this operation, the image area (2,2) is selected in the example of FIG. 15A. Note that if it is determined in step S314 that pink-eye correction is unnecessary, the flow advances to step S320.

In step S316, the pink-eye area specification unit 306 specifies any pink-eye correction area (the image area (2,2) in the example of FIG. 15A) in order to define which portion to be corrected out of a portion in which a pink-eye effect actually occurs. The flow advances to step S317. In step S317, the pink-eye correction unit 304 performs pink-eye correction for the specified pink-eye correction area and set the pink-eye correction execution flag 908 indicating that pink-eye correction is performed. In step S318-1, the entire image data having undergone pink-eye correction is written in the memory 30 through the image processor 20 and memory controller 22. The data is written at an address different from that of the raw data of the image written in step S309 as a different file name. In step S319, the coordinate data of the pink-eye correction area, the procedure for pink-eye correction, parameters, and the like are also written in the memory 30 through the image processor 20 and memory controller 22. Similarly to step S318-1, the data are written at an address different from that of the raw data of the image written in step S309 as a different file name.

Then, the flow advances to step S320 to determine on the basis of the set photography mode whether frame processing is necessary. If frame processing is necessary, the flow advances to step S321. In step S321, the pink eye-corrected image data or original image data written in the memory 30 is read in accordance with the pink-eye correction flag 907 using the memory controller 22 and even the image processor 20 and pink-eye detection correction unit 300, as needed, to perform vertical addition. In step S322, color processes are sequentially performed, and the processed image data is written in the memory 30. In step S323, image data is read from the memory 30, and the image data is transferred to the display memory 24 through the memory controller 22 to display the image. After the series of processing operations, the photographing process routine (step S129) ends.

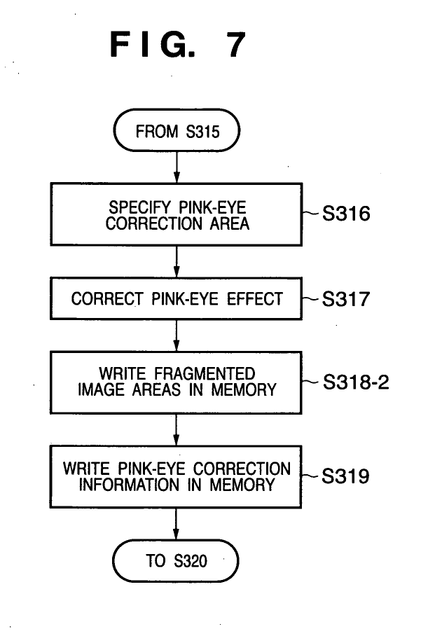

FIG. 7 is a flowchart showing the first modification of the photographing process according to the first embodiment. The flowchart shows steps as an alternative to steps S316 to S319 in the flowchart of FIG. 6B. The same reference numerals as in FIG. 6B denote the same steps. The remaining processing steps not shown in FIG. 7 are the same as those in FIGS. 6A and 6B.

If an area containing a pink-eye effect is selected in step S315 in FIG. 6B, the flow advances to step S316. In step S316, which portion to be corrected out of a portion in which a pink-eye effect actually occurs is determined. More specifically, the pink-eye area specification unit 306 specifies a pink-eye correction area. In step S317, pink-eye correction is performed for the specified pink-eye correction area, and the pink-eye correction execution flag 908 indicating that pink-eye correction is performed is set. The flow advances to step S318-2. In step S318-2, fragmented image data having undergone pink-eye correction (i.e., image data of only a pink eye-corrected image area) is written in the memory 30 through the image processor 20 and memory controller 22. With this operation, only the image data of the image area (2,2) in FIG. 15A is written. The data is written at an address different from that of the raw data of the image written in step S309 as a different file name. In step S319, the coordinate data of the pink-eye correction area, the procedure for pink-eye correction, parameters, and the like are also written in the memory 30 through the image processor 20 and memory controller 22. Similarly to step S318-2, the data are written at an address different from that of the image data as a different file name. The flow advances to step S320.

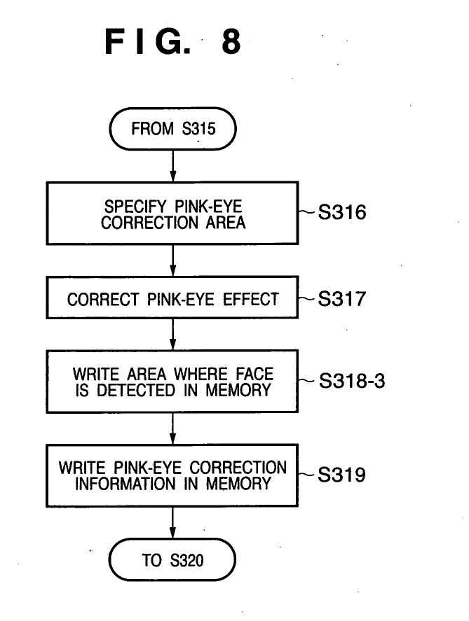

FIG. 8 is a flowchart showing the second modification of the first embodiment. The flowchart shows steps as an alternative to steps S316 to S319 in the flowchart of FIG. 6B. The same reference numerals as in FIG. 6B denote steps which perform the same processes. The remaining processing steps not shown in FIG. 8 are the same as those in FIGS. 6A and 6B.

If an area containing a pink-eye effect is selected in step S315 in FIG. 6B, the flow advances to step S316. In step S316, which portion to be corrected out of a portion in which a pink-eye effect actually occurs is determined. More specifically, the pink-eye area specification unit 306 specifies a pink-eye correction area. In step S317, pink-eye correction is performed for the specified pink-eye correction area, and the pink-eye correction execution flag 908 indicating that pink-eye correction is performed is set. The flow advances to step S318-3. In step S318-3, position information and pink eye-corrected image data within a face edge are written in the memory 30 through the image processor 20 and memory controller 22. The data are written at an address different from that of the raw data of the image written in step S309 as a different file name. In step S319, the coordinate data of the pink-eye correction area, the procedure for pink-eye correction, parameters, and the like are also written in the memory 30 through the image processor 20 and memory controller 22. Similarly to step S318-2, the data are written at an address different from that of the image data as a different file name. The flow advances to step S320.

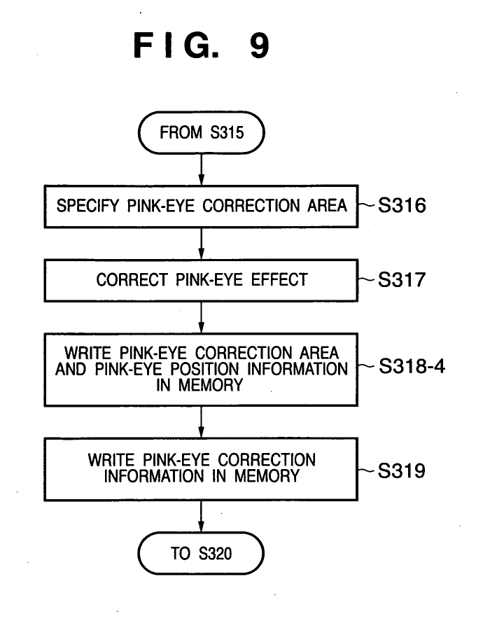

FIG. 9 is a flowchart showing the third modification of the first embodiment. The flowchart shows steps as an alternative to steps S316 to S319 in the flowchart of FIG. 6B. The same reference numerals as in FIG. 6B denote steps which perform the same processes. The remaining processing steps not shown in FIG. 9 are the same as those in FIGS. 6A and 6B.

If an area containing a pink-eye effect is selected in step S315 in FIG. 6B, the flow advances to step S316. In step S316, it is determined which portion to be corrected out of a portion in which a pink-eye effect actually occurs. More specifically, the pink-eye area specification unit 306 specifies a pink-eye correction area and extracts the edge. In step S317, pink-eye correction is performed for the specified pink-eye correction area, and the pink-eye correction execution flag 908 indicating that pink-eye correction is performed is set. In step S318-4, only position information and the pink-eye correction area having undergone pink-eye correction are written in the memory 30 through the image processor 20 and memory controller 22. The data are written at an address different from that of the raw data of the image written in step S309 as a different file name. The flow advances to step S320.

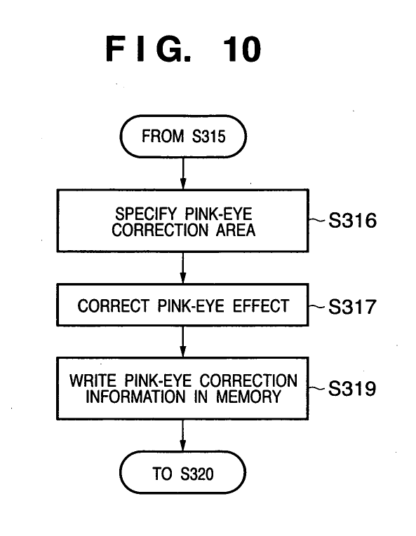

FIG. 10 is a flowchart showing the fourth modification of the first embodiment. The flowchart shows steps as an alternative to steps S316 to S319 in the flowchart of FIG. 6B. The same reference numerals as in FIG. 6B denote steps which perform the same processes. The remaining processing steps not shown in FIG. 10 are the same as those in FIGS. 6A and 6B.

If an area containing a pink-eye effect is selected in step S315 in FIG. 6B, the flow advances to step S316. In step S316, it is determined which portion to be corrected out of a portion in which a pink-eye effect actually occurs. More specifically, the pink-eye area specification unit 306 specifies a pink-eye correction area and extracts the edge. In step S317, pink-eye correction is performed for the specified pink-eye correction area, and the pink-eye correction execution flag 908 indicating that pink-eye correction is performed is set. The flow advances to step S319. In step S319, the coordinate data of the pink-eye correction area, the procedure for pink-eye correction, parameters, and the like are also written in the memory 30 through the image processor 20 and memory controller 22. The flow advances to step S320.

As described above, according to the first embodiment, pink-eye detection and pink-eye correction can automatically be performed within a camera in electronic flash photography, and corrected image data can be stored together with an original image. This makes it possible to perform pink-eye correction (pink-eye editing) suited to the preferences of the user for the original image even if the user is dissatisfied with pink eye-corrected image.

Fragmented areas are set for the entire original image, and image information serving as a result of pink-eye correction is stored for each fragmented area. For this reason, both the pink eye-corrected image and the uncorrected original image can be stored with a smaller memory capacity in a shorter time.

Only the original image, the procedure for pink-eye correction, and various parameters are stored. Accordingly, both information equivalent to the pink eye-corrected image and the uncorrected original image can be stored with a smaller memory capacity in a shorter time.

In display (editing), the pink eye-corrected image or uncorrected original image can be reconstructed from stored image data with a small memory capacity. This makes it possible to view a pink eye-corrected window quickly and easily perform operation suited to the purpose of the user.

A camera which stores two kinds of images, i.e., a currently used raw image of a photographed image before development such as a RAW file, JPEG file, or the like and an image after development or thinning-out/compression can store a pink eye-corrected image or an original image not to be subjected to pink-eye correction without changing the memory capacity.

In the above embodiment, the pink-eye detection/pink-eye correction processes are performed at a time in the photographing process (step S129). However, the processes may be performed immediately before the recording (storage) process (step S134).

The pink-eye correction and storage processes are automatically performed within a camera. Alternatively, the storage may be performed only if the photographer may confirm the state of pink-eye correction by quick review display and gives OK.

If the result of pink-eye correction is unsatisfactory in quick review display, the user may perform editing using an editing function (not shown) and store the editing result in a storage medium.

The present invention incorporates any fragmented image data as far as there are two kinds of image data, i.e., image data not having undergone pink-eye correction and pink eye-corrected image data, and they can be replaced with each other.

The present invention also incorporates the use of information which can be reconstructed to pink eye-corrected image data and image data not having undergone pink-eye correction. Examples of the information are data such as the position information, the correction procedure, the correction parameters, and the like in-pink-eye correction.

### Second Embodiment

FIGS. 12A and 12B are flowcharts for explaining the photographing process (step S129) according to the second embodiment of the present invention.

Referring to FIGS. 12A and 12B, steps S401 to S408 are the same as steps S301 to S308 in FIG. 6A, and a description thereof will be omitted.

In step S409, the image processor 20 performs so-called developing processing including various kinds of correction and AWB. In step S410, a face detection unit 310 connected to the image processor 20 detects a face portion from developed image data. In step S411, a first face area specification unit 312 specifies in which area of fragmented images the detected face area is located. This process has been described with reference to FIGS. 15A and 15B.

In step S412, a pink-eye detection unit 302 detects any pupil from each image area specified in step S411, determines whether the detected pupil contains any pink-eye effect, and determines whether the pink-eye effect is at a level which requires correction. If it is determined that pink-eye correction should be performed, the flow advances to step S413. In step S413, a second face area specification unit 314 determines whether each image area specified in step S411 contains any pink-eye effect and selects any image area containing a pink-eye effect. In step S414, only data of a specific area of raw image data corresponding to the specified image data is written in a memory 30 through a memory controller 22. In step S415, a pink-eye area specification unit 306 specifies which image area to be corrected out of a portion in which a pink-eye effect actually occurs. The area to be corrected will be referred to as a pink-eye correction area hereinafter. In step S416, a pink-eye correction unit 304 performs pink-eye correction for the pink-eye correction area specified in step S415 and set ON a pink-eye correction execution flag 908 indicating that pink-eye correction is performed. In step S417, the entire image data having undergone pink-eye correction is written in the memory 30 through the image processor 20 and memory controller 22. The data is written at an address different from that of the raw data of the image written in step S414 as a different file name. In step S418, the coordinate data of the pink-eye correction area, the procedure for pink-eye correction, parameters, and the like are also written in the memory 30 through the image processor 20 and memory controller 22. Similarly to step S417, the data are written at an address different from that of the written image data as a different file name.

Subsequent steps S420 to S423 are the same as steps S320 to S323 in FIG. 6B, and a description thereof will be omitted.

As described above, according to the second embodiment, both the entire image having undergone pink-eye correction and an uncorrected partial image are stored for a photographed image. Accordingly, pink-eye correction suited to the preferences of the user can easily be performed on the basis of an original image even if the user is dissatisfied with the pink eye-corrected image.

Fragmented areas are set for the entire original image, and image information serving as a result of pink-eye correction is stored for each fragmented area. For this reason, both the pink eye-corrected image and the uncorrected original image can be stored with a smaller memory capacity in a shorter time.

Only the original image, the procedure for pink-eye correction, and various parameters are stored. Accordingly, both information equivalent to the pink eye-corrected image and the uncorrected original image can be stored with a smaller memory capacity in a shorter time.

Desired display can easily be performed by calling up the pink eye-corrected image or (reconstructed) original image from the stored image data with a small capacity and processing the image.

The present invention is not limited to the above-mentioned embodiment. For example, the present invention includes any fragmented image data as far as there are two kinds of image data, i.e., image data not having undergone pink-eye correction and pink eye-corrected image data, and they can be replaced with each other.

An effect equivalent to that obtained by the present invention can be obtained by having data such as information which can be reconstructed to pink eye-corrected image data and image data not having undergone pink-eye correction. Examples of the information are data such as the position information, the correction procedure, the correction parameters, and the like in pink-eye correction.

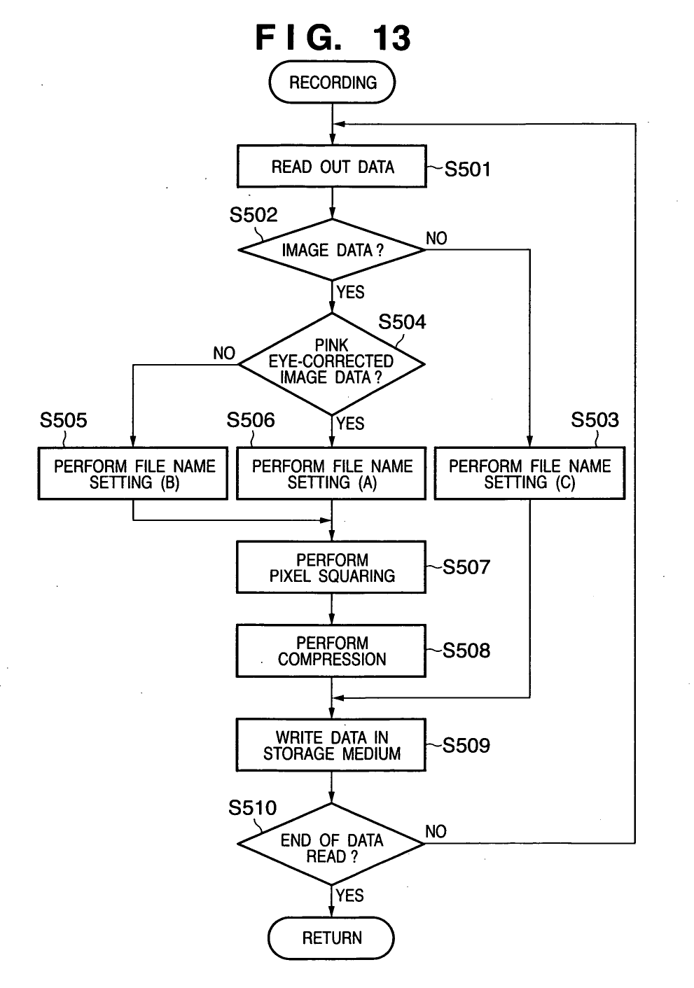

FIG. 13 is a flowchart showing the details of the recording (storage) process in step S134 of FIG. 4B according to this embodiment.

In step S501, data stored in the memory 30 is read through the memory controller 22. In step S502, it is determined whether the data comprises image data or various kinds of parameters and information in pink-eye correction. If the data in the memory 30 is not image data, i.e., the data comprises the various kinds of parameters and information in pink-eye correction, the flow advances to step S503. In step S503, a file name obtained by appending information indicating the ordinal number of a predetermined file to the name of the predetermined file is set for the data (the various kinds of parameters and information in pink-eye correction) (file name setting (C)). The flow advances to step S509 to write the file name in a storage medium.

On the other hand, if YES in step S502, the flow advances to step S504 to determine whether the data is pink eye-corrected image data. This can be determined on the basis of whether the pink-eye correction execution flag 908 is set ON for the image area. If it is determined that the data is image data not having undergone pink-eye correction, the flow advances to step S505. In step S505, a file name obtained by appending information indicating the ordinal number of a predetermined file to the name of the predetermined file is set (file name setting (B)). If it is determined in step S504 that the data is pink eye-corrected image data, the flow advances to step S506. In step S506, a file name obtained by appending information indicating the ordinal number of a predetermined file to the name of the predetermined file is set (file name setting (A)). The file name setting operations in steps S503, S505, and S506 will be described in detail later.

After step S505 or S506, the flow advances to step S507. In step S507, the image data written in the memory 30 is read by using the memory controller 22 and even the image processor 20 and pink-eye detection correction unit 300, as needed, and pixel squaring processing which performs interpolation so as to set the pixel aspect ratio to 1:1 is performed, and the processed image data is written in the memory 30. Then, the flow advances to step S508. In step S508, a compression/expansion unit 32 performs image compression according to the set mode for the image data, and the compressed image data is written in a storage medium 200 or 210 such as a memory card, compact flash™ card, or the like through an interface 90 or 94 and a connector 92 or 96. When the writing to the storage medium ends, the flow advances to step S510 to determine whether data reading from the memory 30 has ended. If more data is found, the flow advances to step S501. On the other hand, if the entire data reading has ended, the recording process routine S134 ends.

File names in steps S503, S505, and S507 will be explained. For example, an image without pink-eye correction is named as “IMG_{—}001.red” (file name setting (B)), and an image with pink-eye correction is named as “IMG_{—}001.jpg (file name setting (A)). Correction parameters are read from corresponding correction parameters 909 in a memory 52 and are stored as a file named as “IMG_{—}001.par” (file name setting (C)). Note that portions before extensions of file names are set to a single name (IMG_{—}001), and the file names are distinguished from each other by their extensions. Numeric characters “001” before each extension varies depending on the number of photographed images.

If there are a plurality of areas to be subjected to pink-eye correction within one image, and there are a plurality of corresponding image areas without pink-eye correction, images without pink-eye correction may be named as, e.g., “IMG_{—}001.red1”, “IMG_{—}001.red2”, “IMG_{—}001.red3”, . . . , images with correction may be named as, e.g., “IMG_{—}001.jpg1”, “IMG_{—}001.jpg2”, . . . , and a file of correction parameters may be named as “IMG_{—}001.par”. In this case, information of an image without pink-eye correction with respect to an image with pink-eye correction for the first image is assumed to be stored in the correction parameter file “IMG_{—}001.par”.

According to this embodiment, both image data before pink-eye correction and that after pink-eye correction are stored. This makes it possible to easily perform pink-eye correction suited to the preferences of the user for an original image even if the user is dissatisfied with pink eye-corrected image.

Fragmented image areas are set for the entire original image, and pink-eye correction is performed within each image area to store image information. For this reason, both the pink eye-corrected image and the uncorrected original image can be stored with a smaller memory capacity in a shorter time.

Only the original image, the procedure for pink-eye correction, and various parameters are stored. Accordingly, both information equivalent to the pink eye-corrected image and the uncorrected original image can be stored with a smaller memory capacity in a shorter time.

Note that the present invention is not limited to the above-mentioned embodiment. In the embodiment, each image with correction is assumed to be the entire image “IMG_{—}001.jpg”, and each image before correction corresponding to a pink eye-corrected portion is named as “IMG_{—}001.red1” (and “IMG_{—}001.red2”, “IMG_{—}001.red3”, . . . in the case of a plurality of images). On the contrary, each image without correction may be assumed to be the entire image “IMG_{—}001.jpg”, and each specific partial image corresponding to a pink eye-corrected portion may be named as “IMG_{—}001.red1” (and “IMG_{—}001.red2”, “IMG_{—}001.red3”, . . . in the case of a plurality of images).

The names of extensions are not limited to those described above, and any names may be used as far as the names indicate the relationship between them.

A compressed file is named using an extension “JPG”. However, the same effect can be obtained by performing compression for a file in a different method and naming the file according to the method.

Pink-eye correction parameters and information may constitute a separate file, as has been described in this embodiment. Alternatively, the parameters and information may be described in a file attached to image data such as an EXIF file or the like. In either case, the same effect can be obtained.

FIG. 14 is a flowchart for explaining a modification of the recording process in step S134 of FIG. 4B.

In step S601, data stored in the memory 30 is read through the memory controller 22. In step S602, it is determined whether the data comprises image data or various kinds of parameters and information in pink-eye correction. If the data in the memory 30 comprises the various kinds of parameters and information in pink-eye correction, the flow advances to step S603. In step S603, a file name obtained by appending information indicating the ordinal number of a predetermined file to the name of the predetermined file is set for the data (file name setting (C)). The flow advances to step S611. On the other hand, if YES in step S602, the flow advances to step S604 to determine whether the data is RAW data before development. If it is determined that the data is RAW data before development, the flow advances to step S605. In step S605, a file name obtained by appending information indicating the ordinal number of a predetermined file to the name of the predetermined file is set (file name setting (B)). The flow advances to step S611.

If NO in step S604, the flow advances to step S606 to determine whether the data is pink eye-corrected image data. If it is determined that the data is not pink eye-corrected image data, the flow advances to step S607. In step S607, a file name obtained by appending information indicating the ordinal number of a predetermined file to the name of the predetermined file is set (file name setting (D)). The flow then advances to step S609. If YES in step S606, the flow advances to step S608. In step S608, a file name obtained by appending information indicating the ordinal number of a predetermined file to the name of the predetermined file is set (file name setting (A)). The flow advances to step S609. The file name setting operations in steps S603, S605, S607, and S608 will be described in detail later.

In step S609, pixel squaring processing which performs interpolation so as to set the pixel aspect ratio to 1:1 is performed by using the memory controller 22 and even the image processor 20 and pink-eye detection correction unit 300, as needed, and the processed image data is written in the memory 30. In step S610, the compression/expansion unit 32 performs image compression according to the set mode, and the compressed image data is written in the storage medium 200 or 210 such as a memory card, compact flash™ card, or the like through the interface 90 or 94 and the connector 92 or 96. When the writing to the storage medium ends, the flow advances to step S612 to determine whether data reading from the memory 30 has ended. If more data is found, the flow advances to step S601. On the other hand, if the entire data reading has ended, the recording process routine ends.

File names in steps S603, S605, S607, and S608 will be explained. For example, an image before development is named as “IMG_{—}001.crw”, and an image with/without pink-eye correction is named as “IMG_{—}001.jpg” (file name setting (A)). Similarly to the above-mentioned example, correction parameters are stored as a file named as “IMG_{—}001.par”. Note that portions before extensions of file names are set to a single name, and the file names are distinguished from each other by their extensions. The ordinal number of a photographed image is indicated by changing the numeric value of “IMG_{—}001”.

As described above, according to this embodiment, both image data before pink-eye correction and that after pink-eye correction are stored. This makes it possible to easily perform pink-eye correction suited to the preferences of the user for an original image even if the user is dissatisfied with pink eye-corrected image.

A camera which stores two kinds of images, i.e., a currently used raw image of a photographed image before development such as a RAW file, JPEG file, or the like and an image after development or thinning-out/compression can store a pink eye-corrected image or an original image not to be subjected to pink-eye correction without changing the memory capacity.

The present invention is not limited to the above-mentioned embodiment. In the embodiment, both an image with pink-eye correction and one without pink-eye correction are treated as JPG files and are not distinguished from each other. Alternatively, a pink eye-corrected file after development may be stored as a separate file name.

A compressed file is a JPG file, but any other compression scheme may be used and a file name corresponding to this scheme may be given.

Pink-eye correction parameters and information may constitute a separate file, as has been described in this embodiment. Alternatively, the parameters and information may be described in a file attached to image data such as an EXIF file or the like. In either case, the same effect can be obtained.

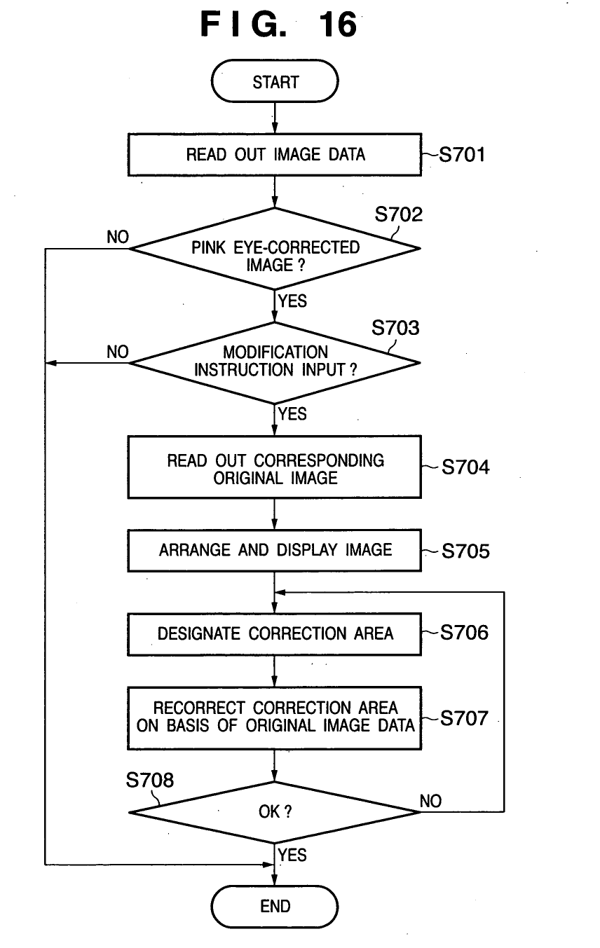

FIG. 16 is a flowchart for explaining a recorrection process performed when a pink eye-corrected image stored in the same manner as described in the embodiment is read out, and the user determines that the result of pink-eye correction is unsatisfactory. Similarly to the above-mentioned flowchart, a program for executing the process shown in the flowchart is stored in the memory 52 and is executed under the control of the system controller 50.

In step S701, image data stored in the memory 30 is read out and is displayed on an optical finder 104 or image display unit 28. In step S702, it is determined whether the readout image data is pink eye-corrected image data. If YES in step S702, the flow advances to step S703. In step S703, it is checked whether the user has input a pink-eye correction modification instruction using an operation unit 70. If a correction instruction is input, the flow advances to step S704 to load photographed image data (original image data) corresponding to the pink eye-corrected image. As described in the embodiment, the loading can easily be performed by specifying the file name (e.g., its extension is “red”). In step S705, the pink eye-corrected image and original image are arranged and displayed on the image display unit 28. If the user designates an area to be modified in the pink eye-corrected image in step S706, the flow advances to step S707 to recorrect the designated pink-eye correction area on the basis of the original image data read in step S704. At this time, the corresponding image correction procedure and parameters stored in the file which stores the correction procedure and parameters may be referred to. Alternatively, the pink eye-corrected image may be replaced with the original image data. In step S708, if the user determines that the modification result is satisfactory and inputs “OK”, the process ends. Otherwise, the flow returns to step S706 to perform the above-mentioned process.

Storing original image data before pink-eye correction together with pink eye-corrected image data makes it possible to perform pink-eye correction again if the pink-eye correction is not satisfactory to the user.

If image data is segmented into a plurality of areas and stored, as described in the above-mentioned embodiment, only original image data of an area corresponding to a pink eye-corrected area can be read out and re-corrected. This makes it possible to reduce a memory capacity for storing original image data and save the time required for recorrection.

### Other Embodiment

Note that the present invention may be applied to either a system constituted by a plurality of devices (e.g., a host computer, interface device, reader, printer, and the like), or an apparatus consisting of a single equipment (e.g., a copying machine, facsimile apparatus, or the like).

The objects of the present invention are also achieved by supplying a storage medium (or recording medium), which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed on the basis of an instruction of the program code by a CPU or the like arranged in a function extension board or a function extension unit, which is inserted in or connected to the computer, after the program code read out from the storage medium is written in a memory of the extension board or unit. For example, execution of the processing by drivers on a PC corresponds to such case.

As described above, according to the above-mentioned embodiment, both a pink eye-corrected image and an image not having undergone pink-eye correction are stored for a photographed image. Accordingly, pink-eye correction suited to the preferences of the user can easily be performed on the basis of an original image even if the user is dissatisfied with the pink eye-corrected image.

Fragmented areas are set for the entire original image, and image information serving as a result of pink-eye correction is stored for each fragmented area. For this reason, both the pink eye-corrected image and the uncorrected original image can be stored with a smaller memory capacity in a shorter time.

Only the original image, the procedure for pink-eye correction, and various parameters are stored. Accordingly, both information equivalent to the pink eye-corrected image and the uncorrected original image can be stored with a smaller memory capacity in a shorter time.

In image display-and editing, the pink eye-corrected image or original image can be reconstructed from stored image data with a small memory capacity. This makes it possible to easily perform operation suited to the purpose of the user.

A camera which stores two kinds of images, i.e., a currently used raw image of a photographed image before development such as a RAW file, JPEG file, or the like and an image after development or thinning-out/compression can store a pink eye-corrected image or an original image not to be subjected to pink-eye correction without changing the memory capacity.

The present invention is not limited to the above embodiment, and various changes and modifications can be made thereto within the spirit and scope of the present invention. Therefore, to apprise the public of the scope of the present invention, the following claims are made.

### CLAIM OF PRIORITY

This application claims priority from Japanese Patent Application No. 2003-427704 filed on Dec. 24, 2003, the entire contents of which are hereby incorporated by reference herein.

1. An image processing apparatus comprising:
pink-eye detection means for detecting whether a pink-eye effect occurs in each of a plurality of image areas into which photographed image data is segmented;
pink-eye correction means for correcting a pink-eye effect detected by said pink-eye detection means; and
storage means for storing the photographed image data and image data of an image area in which a pink-eye effect is detected by said pink-eye detection means and is corrected by said pink-eye correction means.

2. The apparatus according to claim 1, wherein said storage means further stores information that pertains to pink-eye correction by said pink-eye correction means.

3. The apparatus according to claim 1, wherein said storage means further stores information that pertains to an image area containing a pink-eye effect corrected by said pink-eye correction means.

4. The apparatus according to claim 1, wherein the photographed image data stored in said storage means is image data corresponding to an image area containing a pink-eye effect corrected by said pink-eye correction means.

5. An image processing apparatus comprising:
face detection means for detecting a face area of an object from photographed image data;
first face area designation means for designating a first image area containing a face area detected by said face detection means from a plurality of image areas into which the image data-is segmented;
second face area designation means for designating a second image area containing an eye out of the first image area designated by said first face area designation means;
pink-eye detection means for detecting whether the eye in the second image area designated by second face area designation means suffers a pink-eye effect;
pink-eye correction means for correcting a pink-eye effect detected by said pink-eye detection means; and
storage means for storing the photographed image data and image data of the second image area corrected by said pink-eye correction means.

6. The apparatus according to claim 5, wherein said storage means further stores information that pertains to pink-eye correction by said pink-eye correction means.

7. The apparatus according to claim 5, wherein the photographed image data stored in said storage means is image data corresponding to the second image area corrected by said pink-eye correction means.

8. An image processing apparatus comprising:
pink-eye detection means for detecting a pink-eye effect from photographed image data;
pink-eye correction means for correcting a pink-eye effect detected by said pink-eye detection means;
image area designation means for automatically designating an image area containing a pink-eye effect corrected by said pink-eye correction means from a plurality of image areas into which the photographed image data is segmented; and
storage means for storing the photographed image data and image data of an image area designated by said image area designation means.

9. The apparatus according to claim 8, wherein said storage means further stores information that pertains to pink-eye correction by said pink-eye correction means.

10. The apparatus according to claim 8, wherein said storage means further stores information that pertains to an image area containing a pink-eye effect corrected by said pink-eye correction means.

11. The apparatus according to claim 8, wherein the photographed image data stored in said storage means is image data corresponding to an image area containing a pink-eye effect corrected by said pink-eye correction means.

12. An image sensing apparatus comprising:
photographing means for photographing an object using an image sensing element;
pink-eye detection means for detecting whether a pink-eye effect occurs in each of a plurality of image areas into which image data photographed by said photographing means is segmented;
pink-eye correction means for correcting a pink-eye effect detected by said pink-eye detection means; and
storage means for storing the image data photographed by said photographing means and image data of an image area in which a pink-eye effect is detected by said pink-eye detection means and is corrected by said pink-eye correction means.

13. The apparatus according to claim 12, wherein said storage means further stores information that pertains to pink-eye correction by said pink-eye correction means.

14. The apparatus according to claim 12, wherein said storage means further stores information that pertains to an image area containing a pink-eye effect corrected by said pink-eye correction means.

15. The apparatus according to claim 12, wherein the photographed image data stored in said storage means is image data corresponding to an image area containing a pink-eye effect corrected by said pink-eye correction means.

16. An image processing method comprising:
a pink-eye detection step of detecting whether a pink-eye effect occurs in each of a plurality of image areas into which photographed image data is segmented;
a pink-eye correction step of correcting a pink-eye effect detected in the pink-eye detection step; and
a storage step of storing the photographed image data and image data of an image area in which a pink-eye effect is detected in the pink-eye detection step and is corrected in the pink-eye correction step.

17. An image processing method comprising:
a face detection step of detecting a face area of an object from photographed image data;
a first face area designation step of designating a first image area containing a face area detected in the face detection step from a plurality of image areas into which the image data is segmented;
a second face area designation step of designating a second image area containing an eye out of the first image area designated in the first face area designation step;
a pink-eye detection step of detecting whether the eye in the second image area designated in the second face area designation step suffers a pink-eye effect;
a pink-eye correction step of correcting a pink-eye effect detected in the pink-eye detection step; and
a storage step of storing the photographed image data and image data of the second image area corrected in the pink-eye correction step.

18. An image processing method comprising:
a pink-eye detection step of detecting a pink-eye effect from photographed image data;
a pink-eye correction step of correcting a pink-eye effect detected in the pink-eye detection step;
an image area designation step of automatically designating an image area containing a pink-eye effect corrected in the pink-eye correction step from a plurality of image areas into which the photographed image data is segmented; and
a storage step of storing the photographed image data and image data of an image area designated in the image area designation step.

19. The method according to claim 17, wherein in the storage step, information that pertains to pink-eye correction in the pink-eye correction step is further stored.

20. The method according to claim 18, wherein in the storage step, information that pertains to pink-eye correction in the pink-eye correction step is further stored.

21. The method according to claim 18, wherein in the storage step, information that pertains to an image area containing a pink-eye effect corrected in the pink-eye correction step is further stored.

22. The method according to claim 18, wherein the photographed image data stored in the storage step is image data corresponding to an image area containing a pink-eye effect corrected in the pink-eye correction step.

23. The method according to claim 18, wherein the photographed image data stored in said storage step is image data corresponding to the second image area corrected in the pink-eye correction step.

24. The method according to claim 17, further comprising a step of correcting image data containing a pink-eye effect corrected in the pink-eye correction step, on the basis of the photographed image data.

25. The method according to claim 18, further comprising a step of correcting image data containing a pink-eye effect corrected in the pink-eye correction step, on the basis of the photographed image data.

26. A program executing an image processing method defined in claim 17.

27. A program executing an image processing method defined in claim 18.

28. A computer-readable storage medium storing a program defined in claim 26.

29. A computer-readable storage medium storing a program defined in claim 27.
